(19) United States
(12) Patent Application Publication
(10) Pub. No.: US 2020/0340550 A1
(43) Pub. Date: Oct. 29, 2020

(54) FLAT LINK CHAIN

(71) Applicant: THIELE GMBH & CO. KG, Iserlohn (DE)

(72) Inventor: Dirk VORWERK, Hagen (DE)

(21) Appl. No.: 16/347,365

(22) PCT Filed: Oct. 19, 2017
(86) PCT No.: PCT/DE2017/100909

§ 371 Date: Jul. 10, 2020

(30) Foreign Application Priority Data
Nov. 3, 2016 (DE) 10 2016 121 013.7

(51) Int. Cl. F16G 15/12; F16G 13/12

(52) U.S. Cl. CPC F16G 15/12; F16G 13/12

(57) ABSTRACT

The present disclosure relates to a link chain for use underground in mining. The link chain is produced from a steel material and has horizontal links and vertical links. Each horizontal link and each vertical link have sides running parallel to each other and connected to one another at the ends by means of rounded portions. Each side has a smaller cross-sectional area than the cross-sectional area of each rounded portion. The cross-sectional area of the sides of the horizontal link has a smaller width, with the same or smaller height, than the cross-sectional area of the rounded portion, and the cross-sectional area of the sides of the vertical link has a smaller height, with the same or smaller width, than the cross-sectional area of the rounded portion.

### RELATED APPLICATIONS

The present application is a National Phase of International Application Number PCT/DE2017/100909 filed Oct. 19, 2017 and claims priority of German Application Number 10 2016 121 013.7 filed Nov. 3, 2016.

### FIELD

The present disclosure relates to a flat link chain exhibiting horizontal links and vertical links.

### BACKGROUND

The link chains in question are used in mining, for example, in underground mining. They require great strength in order to transmit kinetic energy to extraction machinery as stripper chains, for example, but also as conveyor chains. In chain drives of this kind, the chains are driven via chain wheels in an upper run and a lower run.

For this purpose, the link chains are made from horizontal links which run substantially horizontally in the installed state and vertical links which are arranged to run in a substantially vertically oriented manner in the installed state. The horizontal and vertical links are each separately configured as a rotating chain link. For this purpose, they each have two parallel legs. The legs are connected at their ends via a rounded portion in each case. The horizontal and vertical chain links each engage with one another in the rounded portions. While in use, the chains are also exposed to abrasive wear, in addition to the tensile force being transmitted.

For example, a chain is known from DE 39 30 842 A1 which has a smaller height in the case of the vertical link and a smaller width in the case of the horizontal link.

A cast anchor chain for use in ships in which the legs converging towards one another have a larger cross section, so that a cross section in the rounded portion is also enlarged, is known from FR 876 691.

### SUMMARY

The problem addressed by the present disclosure is that of providing a link chain which is optimized and improved in relation to its own weight and the tensile force being transmitted and also the amount of wear occurring compared with the prior art.

The link chain may also be referred to as a conveyor chain or a flat link chain.

It is used in conveying technology and, in this case, in mining, for example, in underground mining. The individual chain links are produced from a steel material and the link chain has horizontal links and vertical links as the chain links. Each horizontal link and each vertical link has legs running parallel to one another, the legs being connected at the ends by means of a rounded portion in each case.

Each leg has a smaller cross-sectional area than the cross-sectional area of each rounded portion. This is formed both in the case of the horizontal links and in the case of the vertical links.

According to the disclosure, the link chain is characterized in that the cross-sectional area of the legs of the horizontal link in each case has a smaller width with the same or a reduced height in relation to the cross-sectional area of the rounded portion and that, furthermore, the cross-sectional area of the legs of the vertical link in each case has a smaller height with the same or a reduced width in relation to the cross-sectional area of the rounded portion of the vertical link.

The reduced cross-sectional area in the legs compared with the rounded portion initially means that the link chain thereby produced is lighter than a comparable link chain with the same cross-sectional area in the legs. It is also possible for there to be a reduced cross-sectional area in the legs of only one chain link—either a horizontal link or vertical link.

The tensile force being transmitted is not affected by the reduced cross section in the legs. Consequently, the full tensile force that can possibly be transmitted is available due to the cross-sectional area of the rounded portion. The wear occurring during operation of the link chain is reduced on account of the low own weight of the link chain. The smaller cross-sectional areas, in the region of the legs, mean that savings can be simultaneously made on the material costs involved in producing the link chain, which is why the material costs drop too.

. . . the cross-sectional area of the legs of the horizontal link and vertical link is the same in each case. It is therefore possible to optimize the material used in the cross-sectional area. Furthermore, a transitional region is configured starting from the cross-sectional area of the leg to the cross-sectional area of the rounded portion at the end of each leg, from the end of a leg in each case. This is configured in the case of the horizontal link. The transitional region then extends in the side view over an angle greater than 0° to smaller than 45°. For example, the transitional region may also only extend over an angle greater than 0°, greater than 3°, greater than 4°, and greater than 5° to smaller than 35°, smaller than 30°, smaller than 25°, and smaller than 20°. The rounded portion or the cross-sectional area of the rounded portion then begins from here. The cross-sectional area is constantly configured over the entire rounded portion, in the case of the horizontal link.

In the case of the horizontal link, the transitional region is configured as a limit stop for a driver, for example a driver of a scraping conveyor.

So that the link chain can run through guide devices, via chain wheels, the enveloping circle of the cross-sectional area of the leg lies in an enveloping circle of the cross-sectional area of the rounded portion.

Further, an absolute height of the horizontal link is greater than a height of the vertical link. The height of the horizontal link in this case is measured in the horizontal direction; the height of the vertical link in the vertical direction. The height and width specifications relate to the chain link in each case, not to the installation position.

Further, the cross-sectional area of the respective leg is different from a circular contour. This relates to the cross-sectional area of the leg of the vertical link, and also to the cross-sectional area of the leg of a horizontal link. A substantially rectangular cross-sectional configuration with rounded corners is used in this case. An outer side of the leg in each case is rounded in cross section, following a contour of the rounded portion in cross section.

Furthermore, the cross-sectional contour of the leg of the horizontal link is flat in design on the inner side. The side areas also have a flat design in cross section. The corner transitions are rounded in each case. Alternatively, it is possible for the side areas to be configured as two-part surfaces running towards one another at an angle.

The cross-sectional contour of the leg of the vertical link is rectangular in design. In relation to the vertical direction with the vertical link in the installed position, the longer side of the rectangle extends in the horizontal direction and the shorter side in the vertical direction. Here, too, the corner transitions in each case are also rounded.

Furthermore, the cross-sectional area of the rounded portion itself may vary along the rounded portion. This is formed in the case of the vertical link. Following the rounded portion, a varying cross-sectional area therefore results in each case.

This is configured in such a manner that the cross-sectional area of a center plane, following the rounded portion in side view, is configured to increase to an angle of between 45° and 80°. When the maximum increase in the cross-sectional area is reached in the angular range referred to above, the cross-sectional area once again reduces to the leg and to the transitional region. An optimum design of the vertical element takes place in this case during deflection and force transmission on a chain wheel.

### BRIEF DESCRIPTION OF THE DRAWINGS

For an understanding of embodiments of the disclosure, reference is now made to the following description taken in conjunction with the accompanying drawings, in which:

FIG. 1 shows part of a link chain with a horizontal link in side view and a vertical link in plan view,

FIG. 2 shows the view from FIG. 1 with the vertical link in side view and the horizontal link in plan view,

FIG. 3 shows a sectional view through a horizontal link according to the line of intersection A-A from FIG. 1 and

FIG. 4 shows a sectional view according to the line of intersection B-B from FIG. 2.

In the figures, the same reference signs are used for identical or equivalent components, even if and when a repeat description is dispensed with for reasons of simplification.

### DETAILED DESCRIPTION

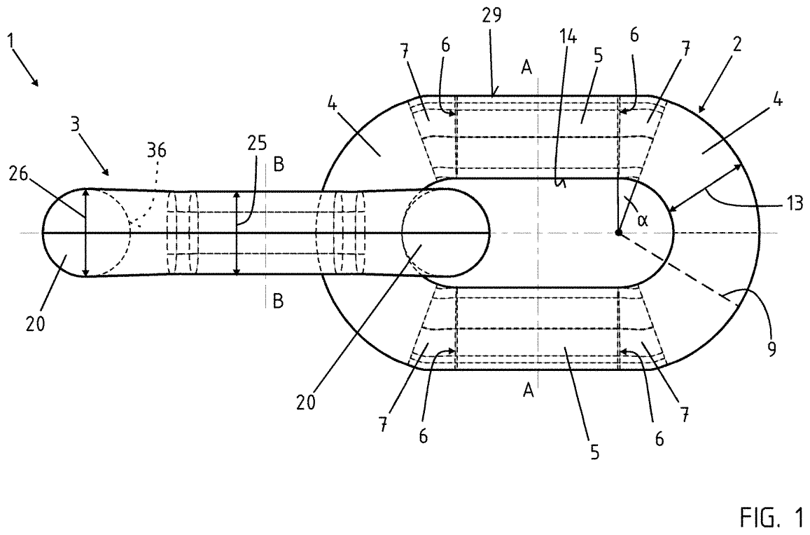

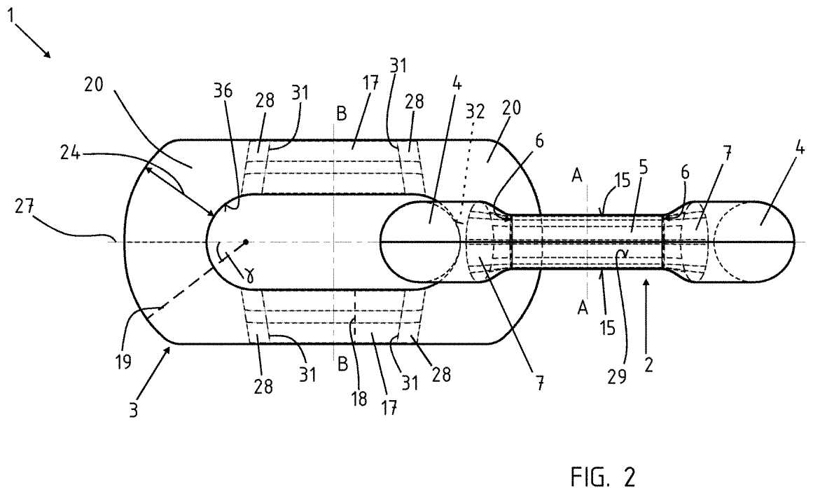

FIGS. 1 and 2 each show a detail from a link chain 1 with a horizontal link 2 and a vertical link 3. In this case, FIG. 1 shows the horizontal link 2 in side view and the vertical link 3 in plan view and FIG. 2 shows the vertical link 3 in side view and the horizontal link 2 in plan view. A further vertical link followed by a horizontal link, etc. are then organized on the right relative to the image plane in a manner not depicted in greater detail. A horizontal link followed by a further vertical link and so on are organized on the left relative to the image plane.

The horizontal link 2 has a rounded portion 4 at each end, said rounded portions being connected in the center via a leg 5 in each case. From one end 6 of the leg 5 there extends a transitional region 7 to the rounded portion 4. According to the disclosure, it is provided that the leg 5 has the same cross-sectional area 8 over its course. The transitional region 7 extends from the end 6 at an angle α greater than 0° to an angle smaller than 45°, so that the leg 5 then merges with the rounded portion 4. The rounded portion 4 has a cross-sectional area 9 in each case which is identical over the course of the rounded portion 4.

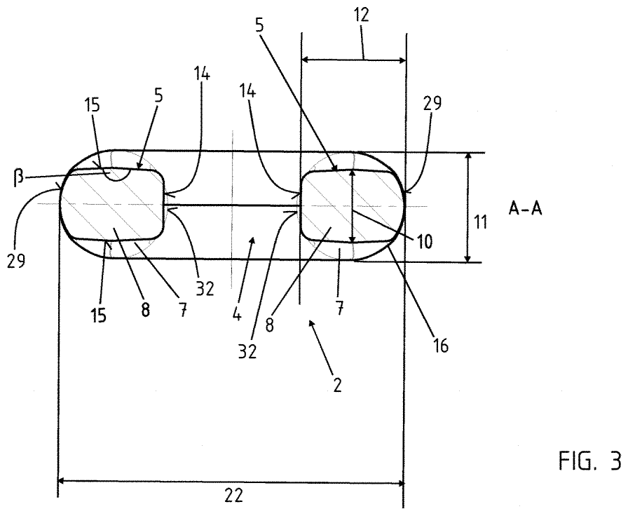

The sectional view A-A is depicted in FIG. 3. The cross-sectional area 8 of the leg 5 in each case is smaller in design compared with a cross-sectional area 9 of the rounded portion 4. The width 10 in the region of the leg 5 is smaller than the width 11 of the rounded portion 4. The height 12 of the leg 5 is smaller than or equal to the height 13 of the rounded portion 4. An inner side 14 in the region of the leg 5 is flat in design.

The inner side 32 of the rounded portion 4 is curved in cross section, or round in design. A side area 15 may likewise be flat in design. The side area 15 may, however, also have a two-part flat design, wherein two areas run towards one another at an angle β. This angle β is obtuse formed within an angle range of less than 180° and more than 150°. Furthermore, an enveloping circle 16 formed about the cross-sectional area 8 of the leg 5 is smaller than or equal to the cross-sectional area 9 of the rounded portion 4. The outer side 29 of the leg 5 has a rounded form in cross section.

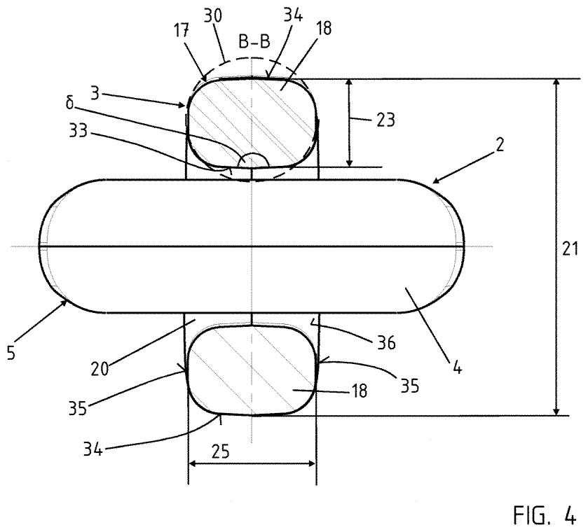

FIG. 4 shows a sectional view along the line of intersection B-B in FIG. 2. The vertical link 3 in this case has a cross-sectional area 18 in the region of its legs 17 which is smaller than a cross-sectional area 19 in the region of the rounded portion 20 of the vertical link 3. Initially, it can be seen by comparison with FIG. 3 that the absolute height 21 of the vertical link 3 is smaller than the height 22 of the horizontal link 2. The height 23 of the leg 17 of the vertical link 3 is smaller than the height 24 of the rounded portion 20 of the vertical link 3. The width 25 of the leg 17 of the vertical link 3 substantially corresponds to the width of the vertical link 3 or to the width 26 of the rounded portion 20 of the vertical link 3, but it may also be smaller. A respective transitional region extends in this case too.

The cross-sectional area 19 of the vertical link 3 varies along the rounded portion 20. From a center plane 27, the cross-sectional area 19 initially increases up to an angle y. The angle y lies between 45° and 80°. In this case, the cross-sectional area 19 of the rounded portion 20 of the vertical link 3 diminishes again towards the leg 17 and then merges with the cross-sectional area 18 of the leg 17. The cross-sectional area 18 of the leg 17 may be constant over the course of the leg 17 up to the end 31 thereof. Here, too, transitional regions 28 are formed from the rounded portion 20 to the leg 17, in which transitional regions the cross section changes.

The inner side 33 of the legs 17 is flat in design. The inner side 33 may also have a two-part design formed by two areas configured at an angle δ to one another. The angle δ lies between 180° and 150°.

An outer side 34 of the leg 17 is flat in design. The side areas 35 may be arched in cross section, but also flat in design, as depicted here.

The corners are rounded in cross section.

An inner side 36 of the rounded portion 20 is rounded in cross section, round in design.

The enveloping circle 30 in which the cross-sectional area 18 of the leg 17 lies is less than or equal to the cross-sectional area 19 of the rounded portion 20.

The foregoing description of some embodiments of the disclosure has been presented for purposes of illustration and description. It is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. It should be understood that various changes, substitutions and alterations can be made hereto without departing from the spirit and scope of the disclosure.

1-12. (canceled)

13. A link chain for underground use in mining, the link chain made of a steel material and comprising:
horizontal links and vertical links,
wherein each of the horizontal links and vertical links has
legs running parallel to one another, and
rounded portions connecting ends of the legs, wherein a cross-sectional area of each of the legs is smaller than a cross-sectional area of each of the rounded portions,
wherein the horizontal links and the vertical links engage with one another at the rounded portions,
wherein, in each of the horizontal links,
the cross-sectional area of each of the legs has a width smaller than a width of the cross-sectional area of each of the rounded portions, and
the cross-sectional area of each of the legs has a height equal to or smaller than a height of the cross-sectional area of each of the rounded portions,
wherein, in each of the vertical links,
the cross-sectional area of each of the legs has a height smaller than a height of the cross-sectional area of each of the rounded portions, and
the cross-sectional area of each of the legs has a width equal to or smaller than a width of the cross-sectional area of each of the rounded portions,
wherein the cross-sectional area of each of the legs of the horizontal links and vertical links is different from a circular contour, and
wherein a height of each of the horizontal links is greater than a height of each of the vertical links.

14. The link chain as claimed in claim 13, wherein the cross-sectional areas of the legs of the horizontal link and the vertical link are the same.

15. The link chain as claimed in claim 13, wherein each of the horizontal links and vertical links comprises, at each end of each of the legs, a transitional region which starts from the cross-sectional area of the leg to the cross-sectional area of one of the rounded portions and extends in a side view over an angle greater than 0 to smaller than 45 degrees.

16. The link chain as claimed in claim 15, wherein the transitional region of each of the horizontal links is configured as a limit stop for a driver.

17. The link chain as claimed in claim 13, wherein, in each of the horizontal links and vertical links, an enveloping circle of the cross-sectional area of each of the legs lies in an enveloping circle of the cross-sectional area of one of the rounded portions.

18. The link chain as claimed in claim 13, wherein, in each of the horizontal links, the cross-sectional area of each of the legs is rounded on an outer side, and follows an outer side of the cross-sectional area of one of the rounded portions.

19. The link chain as claimed in claim 18, wherein the cross-sectional area of each of the legs of each of the horizontal links is flat on an inner side.

20. The link chain as claimed in claim 13, wherein the cross-sectional area of each the legs of each of the vertical links has a rectangular configuration with rounded corners.

21. The link chain as claimed in claim 13, wherein the cross-sectional area of at least one of the rounded portions of at least one of the vertical links varies.

22. The link chain as claimed in claim 13, wherein a cross-sectional area of each of the vertical links is configured from a center plane following one of the rounded portions, increasing to an angle between 45 and 80 degrees, and then decreasing towards one of the legs.

23. The link chain as claimed in claim 19, wherein the cross-sectional area of each of the legs of each of the horizontal links is flat on side areas which connect the inner side and the outer side.

24. The link chain as claimed in claim 19, wherein the cross-sectional area of each of the legs of each of the horizontal links has side areas which connect the inner side and the outer side, and the side areas each have two parts that run towards one another at an angle.
